(19) United States
(12) Patent Application Publication
(10) Pub. No.: US 2026/0223856 A1
(43) Pub. Date: Aug. 6, 2026

(54) SILVER-CARRYING GLASS ANTIBACTERIAL AGENT AND TRANSPARENT ANTIBACTERIAL RESIN PRODUCT AND ARTICLE THEREOF

(71) Applicant: ANHUI ZHENGHE MATERIALS LTD., CHUZHOU (CN)

(72) Inventors: ZHENGKUN ZHAO, CHUZHOU (CN); RUIXIN GUO, CHUZHOU (CN); ZHAOXIN LUO, CHUZHOU (CN); KAI XU, CHUZHOU (CN); YAQI SHI, CHUZHOU (CN); HONGFANG PENG, CHUZHOU (CN)

(73) Assignee: ANHUI ZHENGHE MATERIALS LTD., CHUZHOU (CN)

(21) Appl. No.: 19/445,619

(22) Filed: Jan. 11, 2026

Related U.S. Application Data
(63) Continuation of application No. PCT/CN2025/075636, filed on Feb. 3, 2025.

(51) Int. Cl. A01N 59/16; A01P 1/00

(52) U.S. Cl. CPC A01N 59/16; A01P 1/00

(57) ABSTRACT

The present application relates to a field of antibacterial materials and particularly provides a silver-carrying glass antibacterial agent and transparent antibacterial resin product and article thereof. The silver-carrying glass antibacterial agent includes 11-15 mol % of P₂O₅, 25-35 mol % of B₂O₃, and 50-60 mol % of MgO, based on a total mole amount of each component and calculated as oxides; and the silver-carrying glass antibacterial agent contains 0.1-3 wt % of Ag₂O, 0.003-0.05 wt % of Co₂O₃, and 0.01-0.5 wt % SiO₂ by weight. The antibacterial transparent resin product and article contain the above silver-carrying glass antibacterial agent, with a silver migration concentration of less than 5 ppb and a haze increase value of less than 5%.

### CROSS-REFERENCE TO RELATED APPLICATION

This application is a continuation of PCT/CN2025/075636, filed on Feb. 3, 2025 and claims priority of Chinese Patent Application No. 202410349304.2, filed on Mar. 26, 2024, the contents of which are hereby incorporated by reference.

### TECHNICAL FIELD

The present application relates to a field of antibacterial materials, particularly to a silver-carrying glass antibacterial agent and transparent antibacterial resin product and article thereof.

### BACKGROUND

In recent years, the fields related to microbiology and human health, such as disease prevention, public health, and environmental safety, have received focused attention. With the continuous improvement of people's living standards, there is an increasing demand for high transparency articles that can achieve antibacterial functions. The existing technology mainly relies on the addition of organic antibacterial and antifungal agents and glass antibacterial agents, but organic antibacterial and antifungal agents have poor safety and poor temperature resistance, which are not optimal antibacterial solution for transparent antibacterial polymer materials. Meanwhile, generally used silver-carrying glass antibacterial agents have better transparency than zinc-carrying glass antibacterial agents, but their transparency when applied to transparent polymer materials is not ideal. Moreover, when the processing temperature exceeds 260-280° C. and there are benzene rings and carbon-carbon double bonds in the polymer materials, the silver ions are prone to change color.

Patent CN200410007612.X: the antibacterial glass composition provided includes 0.1-5.0 wt % Ag₂O, and further includes 30-60 mol % P₂O₅, 1-15 mol % of one or more compounds selected from the group consisting of K₂O, Na₂O, and Li₂O, 35-55 mol % of one or more compounds selected from the group consisting of MgO, CaO, and ZnO, and 0.01-3 mol % of one or more compounds selected from La₂O₃ and Y₂O₃. It is found that when the P₂O₅ molar amount of the glass antibacterial composition exceeds 40%, or the molar amount of its alkaline earth metal oxide is less than 50%, or it contains La₂O₃ and Y₂O₃, the haze of the corresponding articles obtained when applied to polyester and polycarbonate will significantly increase, both greater than 20%.

Patent CN201210310233.2: the antibacterial glass composition includes the following components in weight percentage: ZnO 50-60 wt %, preferably 50-55 wt %; Ag₂O 0-0.09 wt %, preferably 0.01-0.05 wt %. It may further include: P₂O₅ 30-40 wt %, preferably 35-40 wt %; Na₂O or K₂O 6-18 wt %, preferably 8-10 wt %. When the glass antibacterial agent is applied to polyester and polycarbonate, the haze of the corresponding articles will significantly increase, both greater than 20%.

Patent CN1202034C: a phosphate glass including 0.2-5 wt % of Ag₂O, 1-50 wt % of ZnO, 0.1-15 wt % of CaO, 0.1-15% of B₂O₃, 30-80 wt % of P₂O₅, and ZnO/CaO weight ratio of 1.1-15%, based on the overall weight of 100% by weight. When the glass antibacterial agent is applied to polyester and polycarbonate, the haze of the corresponding articles will significantly increase.

Patent CN1323588C: a borosilicate glass antibacterial agent includes 0.1-2 wt % of Ag₂O, 40.5-49 wt % of ZnO, 6-9.5 wt % of SiO₂, 30.5-39.5 wt % of B₂O₃, 2-10 wt % of rare earth metal oxide, 6-7.5 wt % of Na₂O, and 0.01-5 wt % of CeO₂. When the glass antibacterial agent is applied to polyester and polycarbonate, the haze of the corresponding products will also significantly increase.

In view of this, the present application is proposed.

### SUMMARY

The present application provides a silver-carrying glass antibacterial agent, including 11-15 mol % of P₂O₅, 25-35 mol % of B₂O₃, and 50-60 mol % of MgO, based on a total mole amount of each component and calculated as oxides; in which the silver-carrying glass antibacterial agent contains 0.1-3 wt % of Ag₂O, 0.003-0.05 wt % of Co₂O₃, and 0.01-0.5 wt % SiO₂ by weight.

As constituents similar to the above-mentioned components of the glass antibacterial agent, a specified 0.0001-5 wt % of components selected from the group consisting of CeO₂, CaO, CuO, ZnO, Al₂O₃, Na₂O, and V₂O₅, as well as a combination thereof may be added, within the scope of the present application.

In the present application, the preferred content of P₂O₅ is 11-15 mol %, and the content of B₂O₃ is 25-35 mol %, which are the main components of the glass network structure forming body (the preferred molar ratio of P₂O₅ to B₂O₃ in the present application is 1:1.5-1:3, and more preferably 1:2, as the glass network structure forming body). Through experiments, it has been found that, it is necessary to increase the content of B₂O₃ in the glass structure, in order to obtain a more stable glass with P₂O₅ and B₂O₃ as the main network forming body. An increase in the proportion of structural units BO₃ and BO₄ in glass will result in an improvement in network connectivity, thus the structure of the glass will be more stable. Meanwhile, borate networks can inhibit the hydrolysis and dissolution of phosphate networks. Moreover, with the increase of B₂O₃, the melting point and viscosity of the glass can also be reduced, which is beneficial for the formation of the glass. The improvement of stability of phospho-borate glass is beneficial for suppressing the discoloration of silver ions during preparation and application. However, as the molar amount of B₂O₃ further increases, the stability of the glass tends to reduce. When the molar ratio of P₂O₅ to B₂O₃ exceeds 1:5, the application of silver-carrying glass antibacterial agents in polymer materials is prone to change color. When the molar ratio of P₂O₅ to B₂O₃ is less than 1:3, the silver-carrying glass antibacterial agents are prone to change color. When the content of P₂O₅ in the present application is less than 11 mol % and the content of B₂O₃ is less than 25 mol %, it is not easy to vitrify, and the fired glass is prone to precipitate simple substance silver. When the content of P₂O₅ is further lower than 8 mol % or the content of B₂O₃ is further lower than 20 mol %, it will lead to more obvious silver precipitation or discoloration. When the content of P₂O₅ in the present application exceeds 15 mol % and the content of B₂O₃ exceeds 35 mol %, the stability and water resistance of the glass will decrease. When the content of P₂O₅ further exceeds 20 mol % or the content of B₂O₃ further exceeds 40 mol %, the stability and water resistance of the glass will significantly decrease.

It is found in the present application that 0.01-0.5 wt % of SiO₂ can be added to the main network forming body of glass to further increase the stability of the glass and improve its transparency. However, once its content exceeds 0.5 wt %, it will result in a decrease in the amount of non-bridging oxygen, which further reduces silver ions to simple substance silver during the glass preparation process, ultimately leading to discoloration of the glass.

In the present application, a preferred content of MgO is 50-60 mol %. In phospho-borate glass, the content of MgO, as an important network modifier, has a significant impact on the stability of the glass. When the content of MgO is less than 50 mol %, the stability of the glass will decrease, and when the content of MgO is less than 40 mol %, the amount of non-bridging oxygen in the glass network structure will be relatively high, the stability of the glass will significantly decrease, and its ability to resist hydrolysis will more significantly decrease. When the content of MgO exceeds 60 mol %, the melting temperature of the glass will increase, which can easily lead to glass crystallization. Moreover, when the content of MgO exceeds 65 mol %, the melting temperature of the glass will significantly increase, making processing more difficult. At the same time, the glass will be more prone to crystallization, which can damage the transparency and uniformity of the glass. Although zinc oxide and calcium oxide may have a synergistic effect with magnesium oxide, which may be beneficial for the stability of the structure and improve the antibacterial performance, and the selection of magnesium oxide will significantly increase the melting temperature of glass, compared with magnesium oxide, the Ca—O and Zn—O bonds formed by calcium oxide and zinc oxide in glass are weaker, and has lower chemical stability, and they are more prone to crystallization. Their transparency will decrease. And MgO will have a greater regulatory effect on the refractive index of glass. Therefore, MgO is selected as the network modifier of glass in the present application.

The addition of Co₂O₃ in the present application can regulate the absorption of visible and infrared light by glass, and allows cobalt ions to enter the glass network as network modifiers, which can improve the acid and alkali resistance of the glass, enhance its stability in different application scenarios, further suppress the discoloration problem of the glass during application, and improve the transmittance and transparency of the glass. The cobalt oxide within the concentration range defined in the present application exhibits a blue color tone that is not easily visible to the naked eye. When applied to polymer materials, it makes the human eye more comfortable and can neutralize the yellow color caused by possible silver ion discoloration, improving the discoloration resistance and transparency of the silver-carrying glass antibacterial materials. However, when the content of cobalt oxide exceeds 0.05%, there will be significant color development and a decrease in the water resistance of the glass.

In the present application, the Ag₂O is preferably 0.1-3 wt %. When the content of Ag₂O is less than 0.1 wt %, the antibacterial performance is unstable. When the content of Ag₂O exceeds 3 wt %, the antibacterial glass prepared is prone to discoloration during preparation and application.

No alkali metal oxide is added in the present application. The addition of alkali metal oxides will reduce the chemical stability of phospho-borate glass, especially the water resistance of silver-carrying glass, which will lead to the adverse consequences of silver ions changing color more easily in extreme application situations. According to Appendix A of GB/T 17219-1998 Standard for safety evaluation of equipment and protective materials in drinking water system, even the addition of 0.1 mol % alkali metal oxide to silver-carrying glass antibacterial agents will result in a silver ion concentration exceeding 5 ppb.

No CuO is added in the present application, because the addition of copper oxide of greater than one thousandth may result in significant discoloration behavior. In addition, excessive addition of copper oxide can cause the glass to become opaque and result in the breakage of the P—O—P and B—O—B bonds in the main network of the glass, thus leading to a decrease in the water resistance of the glass.

No Al₂O₃ is added in the present application. Even if the addition of alumina further improves the stability of the glass structure, the addition of alumina will cause a further increase in the melting temperature of the glass, which is not beneficial to the melting of the glass. At the same time, the addition of alumina will cause a decrease in the transmittance of the glass and an increase in the refractive index of the glass, resulting in a decrease in the transparency of the corresponding transparent polymer material when the silver-carrying glass antibacterial agent is applied. The present application uses alumina or a substitute for boron oxide, and a content exceeding 1 mol % will significantly increase the melting temperature. A content exceeding 3 mol % will make it unable to be sintered.

No rare earth metal oxide is added in the present application, because even though CeO₂ has a high oxidation-reduction potential, and can suppress the discoloration behavior of silver ion glass antibacterial agents during the firing process, rare earth metal ions have a larger ionic radius and are more likely to occupy the interstitial positions in the glass network of the phospho-borate system, bonding with non-bridging oxygen. During the firing process, silver ions are not easily burned into the glass structure, and under high temperature conditions, reduction reactions are likely to occur, resulting in a decrease in silver ion content in the glass structure and a risk of discoloration and decreased antibacterial performance.

The present application is based on the structure of phospho-borate glass, and alkali metal oxides, copper oxide, zinc oxide, calcium oxide, aluminum oxide, and rare earth metal oxides are not preferred. However, it is not denied that these components may play a role in regulating and improving glass properties in glasses with specific molar ratios of phosphorus oxide, boron oxide, and magnesium oxide, which is also within the protection scope of the present application. The introduction of 0.0001-5 wt % of components such as CeO₂, CaO, CuO, ZnO, Al₂O₃, Na₂O, and V₂O₅ as described in the present application can serve as components that can adjust and improve transparency and stability beyond the optimal ratio range of the glass antibacterial agent composition of the present application, and play a role in improving transparency and stability under conditions beyond the endpoints of each of components content of the present application. However, this treatment method is not preferred.

A method for preparing the silver-carrying glass antibacterial agent of the present application includes the following steps:
(1) mixing the components or their corresponding acids, salts, oxides, and hydroxides thoroughly (natural minerals can also be selected as raw materials, but natural minerals may contain excessive of heavy metals or impurity ions, which are not preferred), and then melting them at a high temperature of 1300-1450° C.; and
(2) quenching the molten material obtained in step (1) to obtain sheet-like or block-shaped glass, and physically crushing the obtained sheet-like or block-shaped glass to produce silver-carrying glass antibacterial agent.

The present application also relates to a transparent antibacterial resin product and article including the silver-carrying glass antibacterial agent of the present application, including but not limited to transparent antibacterial PCTG, PC, PET masterbatch and articles thereof with an effective content of 5-10 wt %.

The transparent antibacterial PCTG, PC, PET resin described in the present application can also be supplemented with dispersants, nucleating agents, etc. as needed to further reduce haze or improve its transmittance. The haze and transmittance of transparent antibacterial PCTG, PC, and PET resins based on the present application are very close to those of base resin materials without antibacterial agents, and their improvement effect is not significant.

The silver-carrying glass antibacterial agent of the present application includes but is not limited to being applied to polymer resin materials such as PP, PE, ABS, PMMA, AS, Tritan, melamine, polyurethane, and silicone, and it may be processed into corresponding articles, such as plastic articles, etc.

The silver-carrying glass antibacterial agent of the present application is applied in water pipes, and the dissolution concentration of silver ions is less than 0.5 ppb, up to 0.5 ppb, which meets the safety evaluation standards of GB/T 17219-1998 for Standard for safety evaluation of equipment and protective materials in drinking water system. However, the data for other silver-carrying glass antibacterial agents exceed 5 ppb, and most of the silver-carrying glass antibacterial agents exceed 10 ppb.

The beneficial effects of the present application are:

The present application conducted systematic experiments and studies on the molar ratio of phosphorus oxide and boron oxide in phospho-borate glasses, laying the foundation for further development and application research of such glasses. The present application has conducted detailed experiments and analysis on the effects of calcium oxide, zinc oxide, and magnesium oxide in the phospho-borate glass system, and selected magnesium oxide with better optical adjustment performance and higher stability as the glass network modifier. This provides data reference for the application of these three metal oxides in other glass systems such as silicate glass and phosphate glass. The present application successfully prepares a silver-carrying glass antibacterial agent, which solves the problem of silver ion discoloration easily caused by processing temperatures exceeding 260° C. and the presence of benzene rings and carbon-carbon double bonds in polymer materials. The silver-carrying glass antibacterial agent of the present application has excellent transparency. The antibacterial polyester and polycarbonate resin and their articles prepared by it have a haze increase value of less than 5% and a transmittance decrease value of less than 2% for a 3 mm thick sample. A haze increase value of less than 1% and a transmittance decrease value of less than 1% can be achieved for particularly preferred articles. The antibacterial performance of the antibacterial material prepared by the present application meets the requirements of GB21551.2-2010.

### BRIEF DESCRIPTION OF DRAWINGS

FIG. 1 shows a scanning electron microscope image of the glass antibacterial agent in Example 3 of the present application;

FIG. 2 shows the laser particle size distribution image of the glass antibacterial agent in Example 3 of the present application; and

FIG. 3 shows the transparency comparison image of the antibacterial PCTG in Example 3 of the present application.

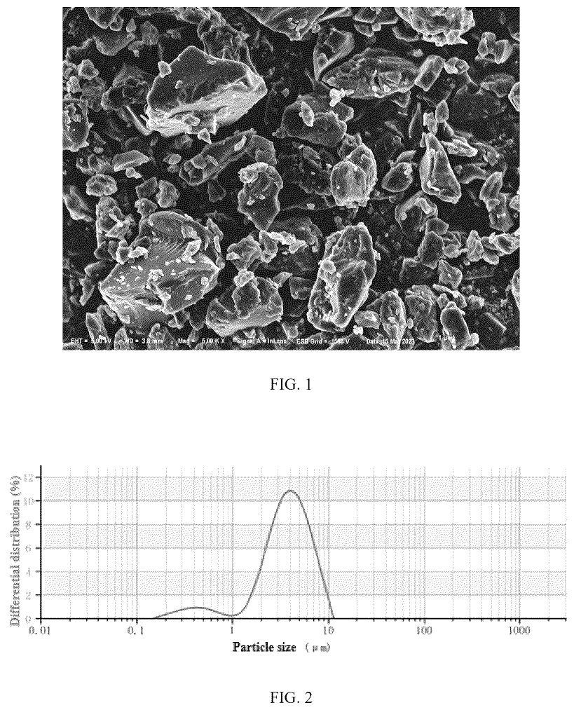

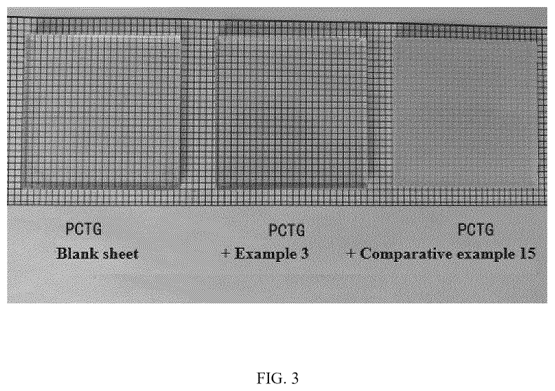

### DETAILED DESCRIPTION OF THE EMBODIMENTS

The technical solutions in the examples of the present application will be clearly and completely described in conjunction with the accompanying drawings hereinafter. Obviously, the described examples are only a part of the examples of the present application, not all of them. Based on the examples of the present application, all other examples obtained by ordinary skilled persons in the art without creative labor are within the protection scope of the present application.

Unless otherwise defined, all technical and scientific terms used in the present application have the same meanings as those commonly understood by those skilled in the art to which the present application belongs. The terms used in this specification of the present application are only for the purpose of describing specific examples and are not intended to limit the present application. The term “and/or” used in the present application includes any of one or more related items listed and all combinations thereof.

### EXAMPLES AND COMPARATIVE EXAMPLES

The embodiments of the present application will be described in detail with reference to the examples hereinafter, but those skilled in the art will understand that the following examples are only used to illustrate the present application and should not be considered as limiting the scope of the present application. If specific conditions are not specified in the examples, conventional conditions can be adopted. The reagents or instruments used without specifying the manufacturer are conventional products that can be commercially obtained.

In the present application, the migration concentration of silver is evaluated according to Appendix A of GB/T 17219-1998 Standard for safety evaluation of equipment and protective materials in drinking water system, and the concentration of silver-carrying glass antibacterial agent in PPR is 0.5‰.

In the present application, antibacterial detection is carried out according to the GB21551.2-2010 standard test method; the morphology of the powder is analyzed using scanning electron microscopy, and the particle size distribution is measured using a laser particle size analyzer.

The following experiments were conducted to verify the effect of the present application.

Examples 1-5: the compounds corresponding to the components and contents of the examples shown in Table 1 were mixed to obtain a mixture, and then the resulting mixture was molten in an electric furnace at 1300-1450° C. for 2-3 hours; the molten mixture was discharged from the electric furnace, and then added into a graphite mold and let it stand at room temperature to obtain block shaped antibacterial glass, the block shaped antibacterial glass was ground using a jaw crusher or ball mill, and physical ultrafine grinding was performed to make the particle size D90 less than 10 microns, to obtain the glass antibacterial agents of Examples 1-5 of the present application. The silver migration concentrations are shown in Table 1.

Comparative examples 1-5: the compounds corresponding to the components and contents of the comparative examples shown in Table 1 were mixed to obtain a mixture, and then the resulting mixture was molten in an electric furnace at 1300-1450° C. for 2-3 hours; the molten mixture was discharged from the electric furnace, and then added into a graphite mold and let it stand at room temperature to obtain block shaped antibacterial glass. the block shaped antibacterial glass was ground using a jaw crusher or ball mill, and physical ultrafine grinding was performed to make the particle size D90 less than 10 microns, to obtain the glass antibacterial agents of Comparative examples 1-5 of the present application. The silver migration concentrations are shown in Table 1.

TABLE 1
components and silver migration concentration of examples and comparative examples

| | Examples | | | | | Comparative examples | | | | |
|---|---|---|---|---|---|---|---|---|---|---|
| Components | 1 | 2 | 3 | 4 | 5 | 1 | 2 | 3 | 4 | 5 |
| P₂O₅(mol %) | 15 | 14 | 13 | 14 | 12 | 13 | 25 | 13 | 13 | 13 |
| B₂O₃(mol %) | 25 | 28 | 30 | 33 | 35 | 30 | 30 | 28 | 30 | 40 |
| MgO(mol %) | 60 | 58 | 57 | 53 | 53 | 57 | 45 | 59 | 57 | 47 |
| SiO₂(wt %) | 0.5 | 0.3 | 0.18 | 0.02 | 0.06 | 0.3 | 0.18 | 2 | 0.18 | 0.18 |
| Co₂O₃(wt %) | 0.05 | 0.003 | 0.008 | 0.006 | 0.03 | 0.3 | 0.008 | 0.1 | 0.1 | 0.008 |
| Ag₂O(wt %) | 0.5 | 1.0 | 1.7 | 2.3 | 3.0 | 1.7 | 1.7 | 1.7 | 3.9 | 1.7 |
| Silver | 0.7 | 0.8 | 0.5 | 2.3 | 4.6 | 12.3 | 16.7 | 9.1 | 19.6 | 14.2 |
| migration (ppb) | | | | | | | | | | |

Examples 6-15: the glass antibacterial agents of Examples 1-5 of the present application was mixed with PCTG resin according to the proportions shown in Table 2, and granulated using a twin-screw, and antibacterial PCTG samples were prepared using an injection molding machine (length and width of 5 cm×5 cm, thickness of 3 mm, all haze and transmittance of the present application were measured using 3 mm thick samples) to obtain the samples of Examples 6-15. The antibacterial performance and transparency results are shown in Table 2.

Comparative examples 6-15: the glass antibacterial agents of Comparative examples 1-5 of the present application was mixed with PCTG resin according to the proportions shown in Table 2, and granulated using a twin-screw, and antibacterial PCTG samples were prepared using an injection molding machine (length and width of 5 cm×5 cm, thickness of 3 mm, all haze and transmittance of the present application were measured using 3 mm thick samples) to obtain the samples of Comparative examples 6-15. The antibacterial performance and transparency results are shown in Table 2.

TABLE 2
antibacterial performance and transparency of antibacterial
polyester and polycarbonate samples of examples

| | | Examples | | | | | | | | | |
|---|---|---|---|---|---|---|---|---|---|---|---|
| | | 6 | 7 | 8 | 9 | 10 | 11 | 12 | 13 | 14 | 15 |
| Glass antibacterial agents | | 1 | | 2 | | 3 | | 4 | | 5 | |
| of examples | | | | | | | | | | | |
| Addition amount % | | 0.4 | 0.6 | 0.3 | 0.4 | 0.2 | 0.3 | 0.2 | 0.3 | 0.2 | 0.3 |
| Antibacterial | Against | 95.7 | 99.9 | 99.9 | 99.9 | 99.9 | 99.9 | 99.9 | 99.9 | 99.9 | 99.9 |
| rate (%) | Escherichia coli | | | | | | | | | | |
| | Against | 91.9 | 99.9 | 99.9 | 99.9 | 99.9 | 99.9 | 99.9 | 99.9 | 99.9 | 99.9 |
| | Staphylococcus | | | | | | | | | | |
| | aureus | | | | | | | | | | |

| | | | | | | | | | | |
|---|---|---|---|---|---|---|---|---|---|---|
| Haze increase value (Δ%) | 2.78 | 3.52 | 1.75 | 2.24 | 0.69 | 0.98 | 1.77 | 2.19 | 2.89 | 3.18 |
| Transmittance decrease | 1.13 | 1.31 | 0.69 | 0.58 | 0.27 | 0.39 | 0.55 | 0.49 | 0.57 | 0.87 |
| value (Δ%) | | | | | | | | | | |

TABLE 3
antibacterial performance and transparency of antibacterial
polyester and polycarbonate samples of comparative examples

| | | Comparative examples | | | | | | | | | |
|---|---|---|---|---|---|---|---|---|---|---|---|
| | | 6 | 7 | 8 | 9 | 10 | 11 | 12 | 13 | 14 | 15 |
| Glass antibacterial agents | | 1 | | 2 | | 3 | | 4 | | 5 | |
| of comparative examples | | | | | | | | | | | |
| Addition amount % | | 0.2 | 0.3 | 0.2 | 0.3 | 0.2 | 0.3 | 0.2 | 0.3 | 0.2 | 0.3 |
| Antibacterial | Against | 97.7 | 99.9 | 99.9 | 99.9 | 95.9 | 99.9 | 99.9 | 99.9 | 99.9 | 99.9 |
| rate (%) | Escherichia coli | | | | | | | | | | |
| | Against | 95.2 | 99.8 | 99.9 | 99.9 | 87.8 | 97.4 | 99.9 | 99.9 | 99.9 | 99.9 |
| | Staphylococcus | | | | | | | | | | |
| | aureus | | | | | | | | | | |

| | | | | | | | | | | |
|---|---|---|---|---|---|---|---|---|---|---|
| Haze increase value (Δ%) | 3.78 | 4.17 | 8.25 | 9.24 | 5.89 | 6.17 | 10.7 | 16.9 | 7.59 | 9.78 |
| Transmittance decrease | 1.16 | 1.33 | 3.49 | 4.78 | 1.87 | 3.39 | 4.87 | 5.76 | 3.87 | 4.18 |
| value (Δ%) | | | | | | | | | | |

Comparative example 16: this comparative example was same as Example 3, except that zinc oxide is used instead of magnesium oxide. It was found that the glass exhibited crystallization phenomenon.

Comparative example 17: this comparative example was same as Example 3, except that half of the magnesium oxide was replaced with zinc oxide. There was no crystallization phenomenon, but in the experiment applied to PCTG resin, it was found that it could easily cause discoloration of PCTG.

Comparative example 18: this comparative example was same as Example 3, except that calcium oxide was used instead of magnesium oxide. It was found that crystallization phenomenon also occurred.

Comparative example 19: this comparative example was same as Example 3, except that 3 mol % alumina was used instead of boron oxide. It was found that the melting temperature needs to be increased by 150° C. to achieve vitrification, and crystallization occurs during the cooling process of the glass liquid.

Comparative example 20: this comparative example was same as Example 3, except that 5 mol % alumina was used instead of boron oxide. It was found that the vitrification was difficult to be achieved during the process of melting glass.

Comparative example 21: this comparative example was same as Example 3, except that 3 wt % sodium oxide was added. It was found that although the melting temperature decreased, it was easy to cause discoloration of PCTG resin in the experiment of applying glass antibacterial agents to PCTG resin.

Comparative example 22: this comparative example was same as Example 3, except that 3 wt % CeO₂ was added. It was found that the vitrification was difficult to be achieved during the melting process.

Comparative example 23: this comparative example was same as Example 3, except that 3 mol % V₂O₅ was used instead of phosphorus oxide. It was found that the melted glass turned yellow.

Comparative example 24: this comparative example was same as Example 3, except that 1 wt % CuO was added. It was found that the glass turned blue and there were dark lumps of unmolten material at the bottom of the crucible.

Comparative example 25: a glass antibacterial agent containing 2.0 wt % Ag₂O, 50 mol % P₂O₅, 7 mol % Na₂O, 40 mol % MgO, and 3 mol % Y₂O₃ was prepared according to patent CN200410007612. X. The silver migration concentration was 39.7 ppb, and the haze value is 26.3 when added to PCTG in an amount of 0.5‰.

Comparative example 26: a glass antibacterial agent containing 2.0 wt % Ag₂O, 30 wt % P₂O₅, 15 wt % B₂O₃, 30 wt % ZnO, and 15 wt % CaO was prepared according to patent CN1202034C. The silver migration concentration was 30.1 ppb, and the haze value is 56.3 when added to PCTG in an amount of 0.5‰.

Comparative example 27: a glass antibacterial agent was prepared by referring to Example 1 of US202010430700.X. The silver migration concentration was 22.7 ppb, and the haze value is 36.3 when added to PCTG in an amount of 0.5‰.

The experimental results of the examples and comparative examples show that, P₂O₅ and B₂O₃ within the molar amount range of the present application are as the main network forming body glass, magnesium oxide, silicon oxide, and cobalt oxide with the content described in the present application are selected as network modifiers, the obtained glass has the advantages of more stable structure, higher light transmittance, and better transparency, and has better color stability in the application and processing process, and lower addition amount required to meet antibacterial performance requirements, and a silver migration concentration of less than 5 ppb, which meets GB/T 17219-1998.

The above description is only a preferred specific example of the present application, but the protection scope of the present application is not limited thereto. Any equivalent substitution or modification by skilled person familiar with the technical field based on the technical solution and inventive concept disclosed in the present application fall within the protection scope of the present application.

What is claimed is:

1. A silver-carrying glass antibacterial agent, comprising 11-15 mol % of P₂O₅, 25-35 mol % of B₂O₃, and 50-60 mol % of MgO, based on a total mole amount of each component and calculated as oxides; wherein the silver-carrying glass antibacterial agent contains 0.1-3 wt % of Ag₂O, 0.003-0.05 wt % of Co₂O₃, and 0.01-0.5 wt % SiO₂ by weight.

2. The silver-carrying glass antibacterial agent according to claim 1, wherein a molar ratio of P₂O₅ to B₂O₃ is 1:1.5-1:3.

3. The silver-carrying glass antibacterial agent according to claim 1, wherein the silver-carrying glass antibacterial agent meets GB/T 17219-1998 and has a silver ion concentration of less than 5 ppb.

4. A transparent antibacterial resin product and article, comprising the silver-carrying glass antibacterial agent according to claim 1.
